(19) United States
(12) Patent Application Publication
(10) Pub. No.: US 2026/0103185 A1
(43) Pub. Date: Apr. 16, 2026

(54) CONTROL DEVICE, CONTROL METHOD, AND STORAGE MEDIUM

(71) Applicant: HONDA MOTOR CO., LTD., Tokyo (JP)

(72) Inventors: Hideto SHIOTANI, Tokyo (JP); Yuki HARA, Tokyo (JP); Daisuke ISHIZUKA, Tokyo (JP); Hideki NAGATOMO, Tokyo (JP)

(73) Assignee: HONDA MOTOR CO., LTD., Tokyo (JP)

(21) Appl. No.: 19/355,371

(22) Filed: Oct. 10, 2025

(30) Foreign Application Priority Data
Oct. 11, 2024 (JP) 2024-178554

(51) Int. Cl. B60W 30/06; B60W 30/18; B60W 50/14; B60W 60/00; G06V 20/58

(52) U.S. Cl. CPC B60W 30/06; B60W 30/18036; B60W 50/14; B60W 60/0021; B60W 60/0023; G06V 20/586; B60W 2050/146; B60W 2420/403; B60W 2540/215

(57) ABSTRACT

A control device for controlling a vehicle, includes: a detection unit configured to detect at least one available parking region; a derivation unit configured to refer to a storage unit that stores travel route information indicating a first travel route along which the vehicle travels to a current position, to derive a second travel route for causing the vehicle to travel from a predetermined point on the first travel route to the at least one available parking region; and a travel control unit configured to cause the vehicle to travel based on the first and second travel route. The travel control unit causes the vehicle to travel from the current position to the predetermined point along the first travel route and then causes the vehicle to travel from the predetermined point to the at least one available parking region along the second travel route.

This application is based upon and claims the benefit of priority from prior Japanese patent application No. 2024-178554, filed on Oct. 11, 2024, the entire contents of which are incorporated herein by reference.

### TECHNICAL FIELD

The present disclosure relates to a control device, a control method, and a storage medium storing a control program.

### BACKGROUND ART

In recent years, improvements in traffic safety have been required to enable inclusion, safety, toughness, and sustainability of urban and human residents. From a viewpoint of improving the traffic safety, for example, developments of a driving assistance technique and an autonomous driving technique for vehicles have been advanced.

As an example of the driving assistance technique, JP2018-203214A discloses a technique in which a peripheral image generated based on an imaging result of an imaging unit provided in a vehicle is displayed on a touch panel, a first symbol representing a parking region where the vehicle can be parked is displayed on the peripheral image, and when a position corresponding to the first symbol is touched, parking in the parking region represented by the first symbol is assisted.

### SUMMARY OF INVENTION

There is room for improvement from a viewpoint of improving convenience of a user.

Aspects of the present disclosure relate to providing a control device, a control method, and a storage medium storing a control program capable of improving convenience of a user.

According to an aspect of the present disclosure, there is provided a control device for controlling a vehicle, including:
a detection unit configured to detect at least one available parking region in which the vehicle is able to be parked based on external environment information on a periphery of the vehicle;
a derivation unit configured to refer to a storage unit that stores travel route information indicating a first travel route along which the vehicle travels to a current position, to derive a second travel route for causing the vehicle to travel from a predetermined point on the first travel route to the at least one available parking region; and
a travel control unit configured to cause the vehicle to travel based on the first travel route and the second travel route, in which
the travel control unit causes the vehicle to travel from the current position to the predetermined point along the first travel route and then causes the vehicle to travel from the predetermined point to the t least one available parking region along the second travel route.

According to another aspect of the present disclosure, there is provided a control method including:
detecting, by a computer that controls a vehicle, an available parking region in which the vehicle is able to be parked based on external environment information in a periphery of the vehicle;
referring, by the computer, to a storage unit configured to store travel route information indicating a first travel route along which the vehicle travels to a current position, to derive a second travel route for causing the vehicle to travel from a predetermined point on the first travel route to the available parking region; and
causing, by the computer, the vehicle to travel based on the first travel route and the second travel route, in which
the causing of the vehicle to travel includes causing the vehicle to travel to the predetermined point along the first travel route and then causing the vehicle to travel from the predetermined point to the available parking region along the second travel route.

According to another aspect of the present disclosure, there is provided a non-transitory computer-readable storage medium storing a control program causing a computer that controls a vehicle, to execute a process including:
detecting an available parking region in which the vehicle is able to be parked based on external environment information in a periphery of the vehicle;
referring to a storage unit configured to store travel route information indicating a first travel route along which the vehicle travels to a current position, to derive a second travel route for causing the vehicle to travel from a predetermined point on the first travel route to the available parking region; and
causing the vehicle to travel based on the first travel route and the second travel route, in which
the causing of the vehicle to travel includes causing the vehicle to travel to the predetermined point along the first travel route and then causing the vehicle to travel from the predetermined point to the available parking region along the second travel route.

According to the present disclosure, it is possible to provide a control device, a control method, and a storage medium storing a control program capable of improving convenience of a user.

### BRIEF DESCRIPTION OF DRAWINGS

Exemplary embodiment(s) of the present invention will be described in detail based on the following figures, wherein:

FIG. 1 is a block diagram showing a schematic configuration of a vehicle 1 including a control device 30 that is an embodiment of a control device of the present disclosure;

FIG. 2 is a diagram showing an example of travel history information 200 stored in a storage unit 35;

FIG. 3 is a diagram showing an example of a situation assumed in the present embodiment;

FIG. 4 is a diagram showing an example of a second travel route Rt2 derived by a derivation unit 33 of the control device 30;

FIG. 5 is a diagram showing an example of travel based on a first travel route Rt1 performed by a travel control unit 34 of the control device 30;

FIG. 6 is a diagram showing an example of travel based on a second travel route Rt2 performed by the travel control unit 34 of the control device 30;

FIG. 7 is a diagram showing an example in which the derivation unit 33 of the control device 30 derives a plurality of second travel routes Rt2;

FIG. 8 is a flowchart (Part 1) showing an example of processing performed by the control device 30;

FIG. 9 is a flowchart (Part 2) showing an example of the processing performed by the control device 30;

FIG. 10 is a diagram showing examples of a third travel route Rt3 and a fourth travel route Rt4 derived by the derivation unit 33 according to a modification; and

FIGS. 11A, 11B, and 11C are diagrams showing examples of travel based on the first travel route Rt1, the third travel route Rt3, and the fourth travel route Rt4 performed by the travel control unit 34 according to the modification.

### DESCRIPTION OF EMBODIMENTS

Hereinafter, an embodiment of a control device, a control method, and a storage medium storing a control program of the present disclosure will be described with reference to the drawings. The drawings are viewed in directions of reference numerals. The following embodiment does not limit the present disclosure, and not all of elements described in the following embodiment are necessary for the present disclosure. Hereinafter, the same or similar elements are denoted by the same or similar reference signs, and the description thereof may be omitted or simplified.

### 1. Vehicle

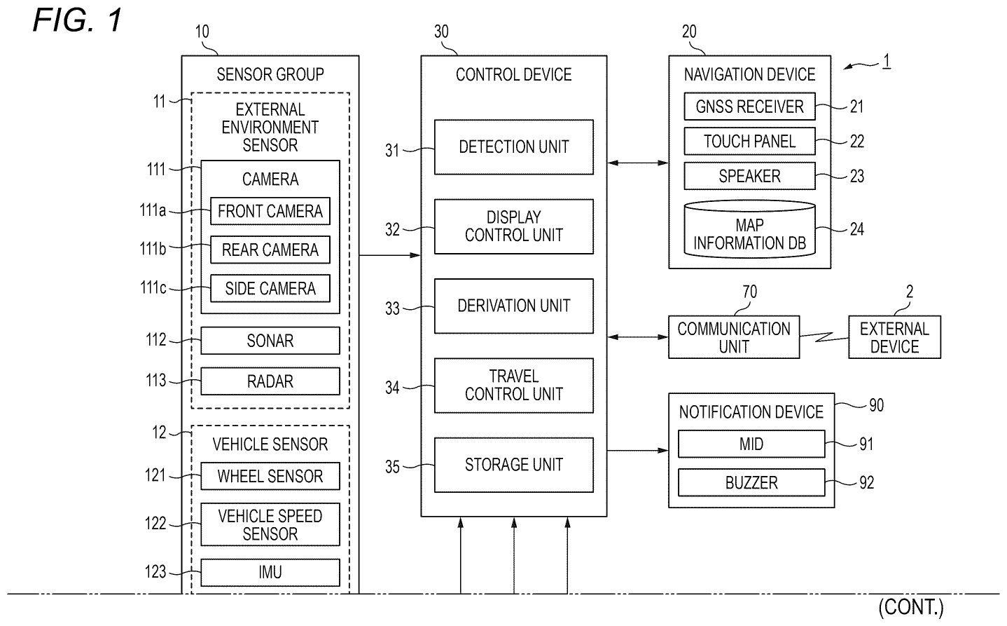

A vehicle 1 according to the present embodiment shown in FIG. 1 is an automobile including a drive source (not shown), and wheels (not shown) including drive wheels driven by power of the drive source and steered wheels that are steerable. As an example, the vehicle 1 may be a four-wheeled automobile including a pair of left and right front wheels and a pair of left and right rear wheels.

The drive source of the vehicle 1 may be an electric motor, an internal combustion engine such as a gasoline engine or a diesel engine, or a combination of an electric motor and an internal combustion engine. The drive source of the vehicle 1 may drive the pair of left and right front wheels, the pair of left and right rear wheels, or the four wheels including the pair of left and right front wheels and the pair of left and right rear wheels. The front wheels and the rear wheels of the vehicle 1 may all be steerable steered wheels, or the front wheels or the rear wheels may be steerable steered wheels.

The vehicle 1 includes a sensor group 10, a navigation device 20, a control device 30, an electric power steering (EPS) system 40, a driving force control system 50, a braking force control system 60, a communication unit 70, and a notification device 90.

The sensor group 10 includes an external environment sensor 11 that acquires external environment information for recognizing a periphery (in other words, surroundings) of the vehicle 1, and a vehicle sensor 12 that acquires information on the vehicle 1 (hereinafter, also referred to as “vehicle information”). The information acquired by each sensor in the sensor group 10 is output to the control device 30, and is used for control of the vehicle 1 (hereinafter, also referred to as “vehicle control”) performed by the control device 30.

The external environment sensor 11 includes, for example, cameras 111, a sonar 112, and a radar 113. The cameras 111 image the periphery of the vehicle 1 including a front side of the vehicle 1, and output image data of an obtained peripheral image to the control device 30. Such image data is an example of the external environment information. As the camera 111, for example, a digital camera using an imaging element such as a charge coupled device (CCD) or a complementary metal oxide semiconductor (CMOS) can be adopted.

More specifically, the cameras 111 include, for example, a front camera 111a, a rear camera 111b, and side cameras 111c. The front camera 111a is provided, for example, on an upper portion of a front window or a front grille (not shown) of the vehicle 1, and images a scene in front of the vehicle 1. The rear camera 111b is provided, for example, near a license plate (in other words, an automobile registration number mark) attached to a rear portion of the vehicle 1, and images a scene behind the vehicle 1. The side cameras 111c are provided, for example, on left and right side mirrors (not shown), and image scenes on lateral sides (that is, left and right sides) of the vehicle 1.

The sonar 112 emits sound waves to the periphery of the vehicle 1 (for example, the front side, the rear side, and the lateral sides of the vehicle 1), and receives reflected sounds from an object present in the periphery of the vehicle 1, thereby detecting a distance to the object from the vehicle 1, an azimuth of the object, and the like, and outputs the detection result to the control device 30. The detection result of the sonar 112 is another example of the external environment information.

The radar 113 emits radio waves to the periphery of the vehicle 1 including the front side of the vehicle 1, and receives reflected waves from an object present in the periphery of the vehicle 1, thereby detecting a distance to the object, a direction of the object, and the like. As the radar 113, for example, a millimeter wave radar can be adopted. The detection result of the radar 113 is another example of the external environment information.

The external environment sensor 11 may include light detection and ranging (LiDAR) instead of or in addition to the sonar 112 and the radar 113. In this case, the LiDAR emits laser light to the periphery of the vehicle 1 including the front side of the vehicle 1, and receives reflected light from an object present in the periphery of the vehicle 1, thereby detecting a distance to the object from the vehicle 1, an azimuth of the object, and the like.

The vehicle sensor 12 includes, for example, a wheel sensor 121, a vehicle speed sensor 122, an inertial measurement unit (IMU) 123, an occupant camera 124, an operation detection unit 125, a steering touch sensor 126, and a shift position sensor 127.

The wheel sensor 121 detects a rotation angle of one or more wheels among the wheels of the vehicle 1. As an example, the wheel sensor 121 detects rotation angles of the left rear wheel and the right rear wheel. As the wheel sensor 121, for example, an angle sensor or a displacement sensor can be adopted.

The vehicle speed sensor 122 detects a vehicle speed VP that is a travel speed of the vehicle 1 (in other words, a movement speed of a vehicle body). For example, the vehicle speed sensor 122 detects the vehicle speed VP based on a rotation speed of a counter shaft (not shown) provided in the vehicle 1.

The inertial measurement unit 123 detects angular velocities of the vehicle 1 in a pitch direction, a roll direction, and a yaw direction, and accelerations of the vehicle 1 in a front-rear direction, a left-right direction, and an upper-lower direction. The vehicle sensor 12 may include, instead of the inertial measurement unit 123, an acceleration sensor that detects an acceleration of the vehicle 1 in a predetermined direction and a gyro sensor that detects an angular velocity of the vehicle 1 in a predetermined direction.

The occupant camera 124 is a digital camera that images an interior of the vehicle 1 and outputs image data of an obtained interior image to the control device 30. For example, the occupant camera 124 can be a so-called “driver monitor camera” provided to be able to image a head of an occupant seated in a driver seat of the vehicle 1 (for example, a user driving the vehicle 1, hereinafter simply referred to as “user”) from the front. As the occupant camera 124, a digital camera using an imaging element such as the CCD or the CMOS can be adopted, similarly to the camera 111.

The operation detection unit 125 detects an operation performed by using an operation input unit 129 that is operable by the user. The operation input unit 129 may include, for example, a switch or a button that receives a parking assist request operation to be described later.

The steering touch sensor 126 detects whether a steering 46 of the vehicle 1 is gripped appropriately. For example, the steering touch sensor 126 is implemented by a capacitance sensor or the like. In this case, the capacitance sensor is provided at a portion touched by the user when the steering 46 is gripped appropriately.

The shift position sensor 127 detects, for example, whether a shift position of a shift lever (not shown) provided in the vehicle 1 is any one of “P (parking)”, “R (reverse)”, “N (neutral)”, and “D (drive)”. When the vehicle 1 may take another shift position (for example, “B (brake)”) other than the “P”, the “R”, the “N”, and the “D”, the shift position sensor 127 may also detect whether the shift position is the other shift position.

The navigation device 20 includes, for example, a global navigation satellite system (GNSS) receiver 21, a touch panel 22, and a speaker 23. The navigation device 20 includes a storage unit (not shown) implemented by a flash memory or the like. The storage unit of the navigation device 20 stores a map information database (DB) 24 and the like.

The map information database 24 includes road network information. The road network information is information representing roads based on a combination of nodes and links connecting the nodes (also referred to as “paths”). Each of the nodes in the road network information represents, for example, a feature of the corresponding road such as an intersection, a corner, or a dead end. In the road network information, for each of the nodes, for example, information indicating a location corresponding to the node (for example, coordinates that enable specifying of one point on a map such as a latitude and a longitude) is set. Further, in the road network information, for each of the links, information indicating nodes at both ends of the link, a road corresponding to the link, a link length, a lane number, a travel direction, a road type, and the like is set.

The GNSS receiver 21 specifies a current position of the vehicle 1 (for example, a latitude and a longitude of a location where the vehicle 1 is located) based on a signal received from a GNSS satellite. For example, the navigation device 20 may acquire a detection result of the vehicle sensor 12 (for example, the wheel sensor 121 or the vehicle speed sensor 122) via the control device 30, and specify or complement the current position of the vehicle 1 by an inertial navigation system (INS) using a detection value of the vehicle sensor 12.

For example, the touch panel 22 is implemented by combining a display device such as a liquid crystal display or an organic light emitting diode (OLED) with a pointing device (for example, a touch pad). The speaker 23 is configured to output sound to the occupant of the vehicle 1 including the user. The touch panel 22 is an example of a notification unit capable of issuing a notification to the user. The speaker 23 is another example of the notification unit capable of issuing a notification to the user.

For example, the navigation device 20 searches for, by referring to the map information database 24, a route from the current position of the vehicle 1 to a destination set by the user using the touch panel 22. Then, the navigation device 20 performs route guidance using the touch panel 22 and the speaker 23 based on the found route.

Further, the navigation device 20 may cause the touch panel 22 to perform a predetermined display according to an instruction from the control device 30. Further, the navigation device 20 may output predetermined information (for example, information indicating an operation received via the touch panel 22) to the control device 30. For example, the navigation device 20 may display, on the touch panel 22, a target parking position setting screen or a parking assist function use recommendation notification to be described later, according to an instruction from the control device 30.

The control device 30 is an example of the control device according to the present disclosure and is a computer that integrally controls the entire vehicle 1. For example, the control device 30 includes, for example, a processor (not shown) that performs various calculations, a storage unit 35 including a non-transitory storage medium that stores various types of information (for example, programs and various types of data), and an input and output unit (not shown) as an interface that controls input and output of data between the inside and the outside of the control device 30.

The control device 30 includes, for example, a detection unit 31, a display control unit 32, a derivation unit 33, and a travel control unit 34 as functional units implemented by the processor executing the programs stored in the storage unit 35. These functional units will be described later, and thus the description thereof will be omitted here. For example, the control device 30 is implemented by one electronic control unit (ECU) or by a plurality of ECUs working in cooperation with each other.

The EPS system 40 includes, for example, a steering angle sensor 41, a torque sensor 42, an EPS motor 43, a resolver 44, and an EPS ECU 45.

The steering angle sensor 41 detects a steering angle θst of the steering 46 and outputs information indicating the detected steering angle θst to the EPS ECU 45. The torque sensor 42 detects a steering torque TQ, which is a torque applied to the steering 46 of the vehicle 1, and outputs information indicating the detected steering torque TQ to the EPS ECU 45.

The EPS motor 43 assists the user in operating the steering 46 by applying, according to an instruction from the EPS ECU 45, a driving force or a reaction force to a steering column 47 coupled to the steering 46. The resolver 44 detects a rotation angle θm of the EPS motor 43 and outputs information indicating the detected rotation angle θm to the EPS ECU 45.

The EPS ECU 45 is a computer which includes, for example, a processor that performs various calculations, a storage unit including a non-transitory storage medium that stores various types of information, and an input and output unit that controls input and output of data between the inside and the outside of the EPS ECU 45 (none is shown), and controls the EPS system 40 (for example, the EPS motor 43). The EPS ECU 45 is implemented by one or two or more ECUs. For example, the EPS ECU 45 controls the EPS system 40 (for example, the EPS motor 43) based on the steering angle θst detected by the steering angle sensor 41, the steering torque TQ detected by the torque sensor 42, the rotation angle θm detected by the resolver 44, and the like. The EPS ECU 45 can also control the EPS system 40 according to an instruction from the control device 30.

The EPS system 40 (for example, the EPS ECU 45) may output, to the control device 30, information indicating the steering angle θst detected by the steering angle sensor 41, the steering torque TQ detected by the torque sensor 42, the rotation angle θm detected by the resolver 44, and the like. Further, the EPS system 40 (for example, the EPS ECU 45) may output information indicating a steering speed ω of the steering 46 to the control device 30. In this case, the steering speed ω is obtained by, for example, differentiating the steering angle θst with respect to time.

The driving force control system 50 includes a driving ECU 51, and is configured to control a driving force of the vehicle 1. The driving ECU 51 is a computer that includes, for example, a processor that performs various calculations, a storage unit including a non-transitory storage medium that stores various types of information, and an input and output unit that controls input and output of data between the inside and the outside of the driving ECU 51 (none is shown), and controls the driving force control system 50. The driving ECU 51 is implemented by one or more ECUs. For example, the driving ECU 51 controls power output from the drive source of the vehicle 1, based on an operation on an accelerator pedal 52 provided in the vehicle 1. The driving ECU 51 can also control the driving force control system 50 (for example, the drive source) according to an instruction from the control device 30.

The braking force control system 60 includes a braking ECU 61, and is configured to control a braking force of the vehicle 1. The braking ECU 61 is a computer that includes, for example, a processor that performs various calculations, a storage unit including a non-transitory storage medium that stores various types of information, and an input and output unit that controls input and output of data between the inside and the outside of the braking ECU 61 (none is shown), and controls the braking force control system 60. The braking ECU 61 is implemented by one or more ECUs. For example, the braking ECU 61 controls the braking force of the vehicle 1 by controlling a brake device (not shown) provided in the vehicle 1, based on an operation on a brake pedal 62 provided in the vehicle 1. Here, the brake device includes, for example, a brake caliper, a cylinder that transmits a hydraulic pressure to the brake caliper, and an electric motor that generates a hydraulic pressure in the cylinder. The braking ECU 61 controls an electric motor of the brake device such that a braking force corresponding to the operation on the brake pedal 62 is generated. The braking ECU 61 can also control the braking force control system 60 (for example, the brake device) according to an instruction from the control device 30.

The communication unit 70 is a communication interface that communicates with an external device 2 under control of the control device 30. That is, the control device 30 may communicate with the external device 2 via the communication unit 70. Examples of the external device 2 include a terminal device (for example, a smartphone) of the user and a server device managed by a manufacturer of the vehicle 1. For example, a mobile communication network such as a cellular line, WI-FI (registered trademark), or Bluetooth (registered trademark) can be used for the communication between the vehicle 1 and the external device 2.

The notification device 90 is a device that issues a notification (for example, an alarm) to the user under the control of the control device 30. The notification device 90 includes, for example, a multi-information display (MID) 91 and a buzzer 92.

The MID 91 is implemented by a display device such as a liquid crystal display or an OLED, and is provided at a position that can be visually recognized by the user (for example, in a meter panel of the vehicle 1). For example, the MID 91 displays a predetermined image according to an instruction from the control device 30. The MID 91 is another example of the notification unit capable of issuing a notification to the user. The MID 91 may be integrated with the touch panel 22 described above.

The buzzer 92 is configured to output a predetermined sound. For example, the buzzer 92 outputs a predetermined alarm sound or a sound effect according to an instruction from the control device 30. The buzzer 92 is another example of the notification unit capable of issuing a notification to the user. The buzzer 92 may be integrated with the speaker 23 described above.

### 2. Control Device

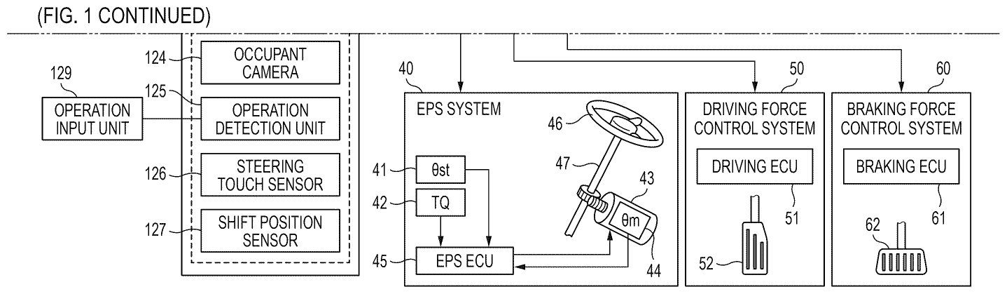

Next, the control device 30 will be described in more detail. First, an example of the information stored in the storage unit 35 will be described with reference to FIG. 2.

### 2-1. Travel History Information Stored in Storage Unit

The storage unit 35 stores, for example, travel history information 200 shown in FIG. 2. As shown in FIG. 2, the travel history information 200 includes, for example, information indicating the position of the vehicle 1, the steering angle θst, and the shift position (for example, “P”, “R”, “N”, or “D”) at each time point. The information indicating the steering angle θst in the travel history information 200 is an example of “control information” in the present disclosure. The information indicating the shift position in the travel history information 200 is another example of the “control information” in the present disclosure.

For example, when the vehicle 1 is manually driven, the control device 30 acquires information indicating the latitude and longitude of the point where the vehicle 1 is located, which is specified by the navigation device 20 (for example, the GNSS receiver 21), the information indicating the steering angle θst detected by the EPS system 40 (for example, the steering angle sensor 41), and the information indicating the shift position detected by the shift position sensor 127, at a predetermined cycle (for example, every 10 [ms]). Then, the control device 30 stores the acquired information indicating these into the storage unit 35 in association with information indicating a time point at the time of acquisition. Accordingly, the travel history information 200 is stored which includes information in which the information indicating the position of the vehicle 1, the information indicating the steering angle θst, and the information indicating the shift position at the same time point during travel based on manual driving are associated with one another.

The travel history information 200 may include other information. For example, as shown in FIG. 2, the travel history information 200 may further include the external environment information at each time point. As an example, the travel history information 200 may include information indicating a front image at each time point as the external environment information. In this case, when the vehicle 1 is manually driven, the control device 30 may acquire the information indicating the latitude and longitude of the point where the vehicle 1 is located, which is specified by the navigation device 20, the information indicating the steering angle θst detected by the EPS system 40, the information indicating the shift position detected by the shift position sensor 127, and the information indicating the front image captured by the front camera 111a at a predetermined cycle, and store the acquired information indicating these into the storage unit 35 in association with the information indicating the time point at the time of acquisition. In this way, the travel history information 200 including information in which the information indicating the position of the vehicle 1, the information indicating the steering angle θst, the information indicating the shift position, and the external environment information at the same time point during travel based on manual driving are associated with one another other can be stored into the storage unit 35.

The travel history information 200 including the information indicating the position of the vehicle 1 at each time point can also be said to be information indicating a temporal transition in the position of the vehicle 1. The temporal transition in the position of the vehicle 1 represents a travel route on which the vehicle 1 has traveled. Therefore, the travel history information 200 includes travel route information indicating a travel route along which the vehicle 1 has traveled. As described above, when the travel history information 200 is stored based on the fact that the vehicle 1 is traveling by manual driving, the travel history information 200 includes the travel route information indicating a travel route (hereinafter also referred to as “first travel route Rt1”) along which the vehicle 1 has traveled based on the manual driving.

In the travel history information 200, the information indicating the steering angle θst associated with the information indicating each position of the vehicle 1 represents the steering angle θst when the vehicle 1 is at the position, that is, an operation state of the steering 46. Therefore, the travel history information 200 may represent the operation state of the steering 46 when the vehicle 1 travels on the first travel route Rt1.

Further, in the travel history information 200, the information indicating the shift position associated with the information indicating each position of the vehicle 1 represents the shift position when the vehicle 1 is at the position, that is, an operation state of the shift lever. Therefore, the travel history information 200 may represent the operation state of the shift lever when the vehicle 1 travels on the first travel route Rt1.

In the present embodiment, the control device 30 stores, into the storage unit 35, the travel history information 200 indicating the first travel route Rt1 of a predetermined distance (for example, 200 [m]) immediately before the vehicle 1 reaches the current position. In other words, the control device 30 deletes, from the storage unit 35, information on a portion of the travel route that is outside the predetermined distance due to the travel of the vehicle 1. Accordingly, a storage area of the storage unit 35 required to store the travel history information 200 can be reduced.

In the present embodiment, the control device 30 includes the storage unit 35 that stores the travel history information 200, but the present disclosure is not limited thereto. That is, the storage unit 35 may be provided outside the control device 30 in a state of being accessible by the control device 30.

### 2-2. Processing Performed by Control Device

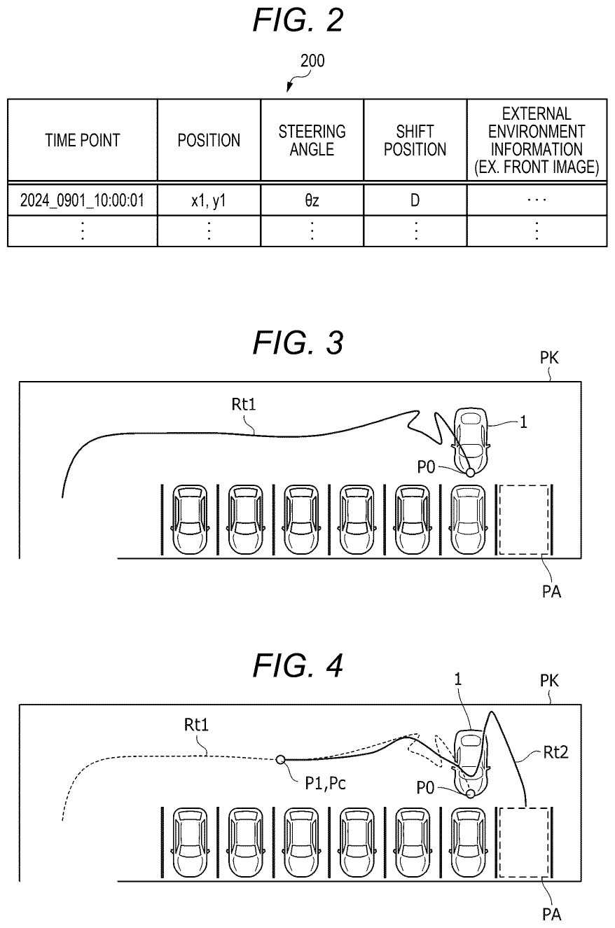

Next, specific examples of processing performed by the control device 30 will be described with reference to FIGS. 3 to 7.

In an example shown in FIG. 3, the vehicle 1 is manually driven by the user and is located at a point P0 in a parking lot PK. That is, in the example shown in FIG. 3, the point P0 is the current position of the vehicle 1. The user attempts to park the vehicle 1 in an available parking region PA, which is an empty parking space in the parking lot PK, by driving himself/herself, but is unsuccessful, and temporarily stops vehicle 1 at the point P0 outside the available parking region PA.

In the example shown in FIG. 3, the first travel route Rt1 is a travel route on which the vehicle 1 travels by manual driving until the vehicle 1 reaches the point P0. Then, the storage unit 35 stores travel history information 200 including travel route information indicating the first travel route Rt1.

In the example shown in FIG. 3, for example, when a predetermined user operation (hereinafter, also referred to as “parking assist request operation”) for requesting to use a parking assist function is received via the touch panel 22 or the operation input unit 129, the detection unit 31 of the control device 30 detects an available parking region PA as an available parking region in which the vehicle 1 can be parked, based on the external environment information acquired via the external environment sensor 11.

The parking assist request operation can be, for example, an operation of tapping a predetermined button displayed on the touch panel 22. The button may be displayed on the touch panel 22 together with the parking assist function use recommendation notification to be described later. The parking assist request operation is not limited thereto, and may be, for example, an operation on a physical switch or button provided on the steering 46 or the like.

When detecting the available parking region, the detection unit 31 may detect, as the available parking region, a parking space (that is, an empty parking space) in which no other vehicle is parked among parking spaces partitioned by white lines or the like, or may detect any region in which the vehicle 1 can be physically parked as the available parking region. Further, the detection unit 31 may detect the available parking region while the vehicle 1 is traveling (for example, when the vehicle 1 is traveling at a low speed). Further, the detection unit 31 may detect an available parking region (for example, the available parking region PA shown in FIG. 3) in which the user is presumed to have attempted to park the vehicle 1. As an example, the detection unit 31 may estimate the available parking region in which the user has attempted to park, based on a position of each available parking region present in the periphery of the vehicle 1 and the travel route of the vehicle 1 indicated by the travel history information 200, and detect the available parking region. In this way, the available parking region (that is, a position desired by the user as a position at which the vehicle 1 is to be parked) in which the user is presumed to have attempted to park can be presented to the user as a candidate for a target parking position.

When the available parking region PA is detected by the detection unit 31, the display control unit 32 of the control device 30 displays, for example, the target parking position setting screen for the user to designate the target parking position, on the touch panel 22. Here, the target parking position setting screen can be, for example, a display screen in which a parking frame image corresponding to each detected available parking region is displayed on an overhead image in which the periphery of the vehicle 1 is drawn from an overhead viewpoint. For example, in a case of the example shown in FIG. 3, since the available parking region PA is detected, a target parking position setting screen is displayed in which a parking frame image corresponding to the available parking region PA is displayed on the overhead image of the periphery of the vehicle 1.

When any parking frame image in the target parking position setting screen displayed on the touch panel 22 is tapped by the user, the control device 30 sets the available parking region corresponding to the parking frame image as the target parking position. In other words, the control device 30 sets the available parking region designated by the user as the target parking position. In the example described here, it is assumed that the available parking region PA is set as the target parking position.

In this case, the derivation unit 33 of the control device 30 derives a second travel route Rt2 for causing the vehicle 1 to travel from a predetermined point (hereinafter, also referred to as “connection point Pc”) on the first travel route Rt1 to the available parking region PA that is the target parking position, while referring to the travel history information 200 stored in the storage unit 35.

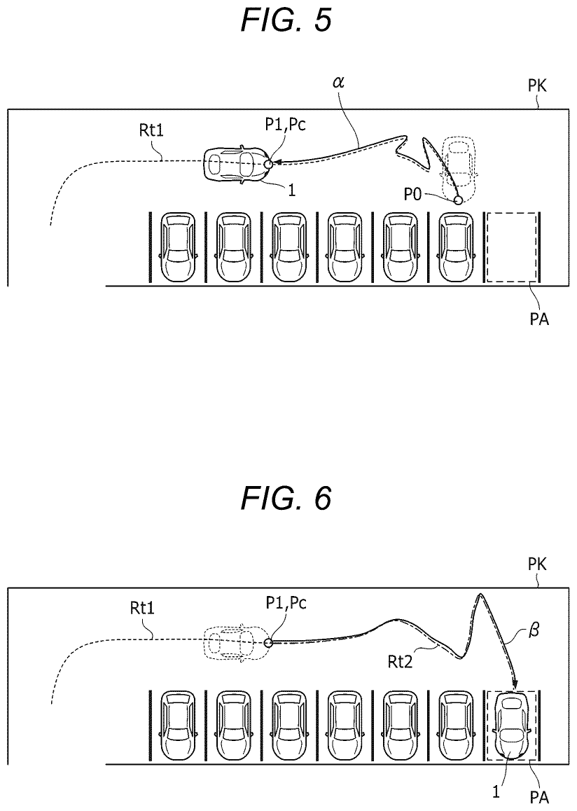

As an example, as shown in FIG. 4, the derivation unit 33 derives, as the second travel route Rt2, a route for causing the vehicle 1 to travel from a point P1 on the first travel route Rt1 to the available parking region PA. At this time, the derivation unit 33 may derive, as the second travel route Rt2, a route through which the vehicle 1 passes when it is attemped to cause the vehicle 1 to travel from the point P1 to the available parking region PA in consideration of specifications (for example, a vehicle body dimension and a minimum turning radius) of the vehicle 1.

Then, the travel control unit 34 causes the vehicle 1 to travel based on the first travel route Rt1 indicated by the travel history information 200 stored in the storage unit 35 and the second travel route Rt2 derived by the derivation unit 33.

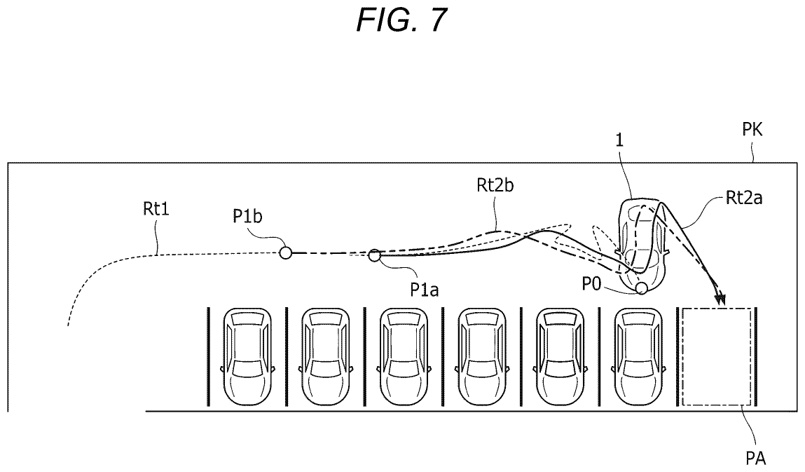

As an example, it is assumed that the second travel route Rt2 shown in FIG. 4 is derived by the derivation unit 33. In this case, as shown in FIG. 5, the travel control unit 34 first causes the vehicle 1 to travel along the first travel route Rt1 from the point P0, which is the current position of the vehicle 1, to the point P1, which is the connection point Pc (see an arrow α in FIG. 5). At this time, the travel control unit 34 may control the steering of the vehicle 1 via the EPS system 40 such that the vehicle 1 travels while tracing a portion of the first travel route Rt1 from the point P0 to the point P1. At this time, the travel control unit 34 may control the driving force of the vehicle 1 via the driving force control system 50, or may control the braking force of the vehicle 1 via the braking force control system 60. However, the present disclosure is not limited thereto, and the driving force or the braking force of the vehicle 1 may be adjusted by the user via the accelerator pedal 52 or the brake pedal 62, for example. In other words, the control device 30 may control only the steering of the vehicle 1.

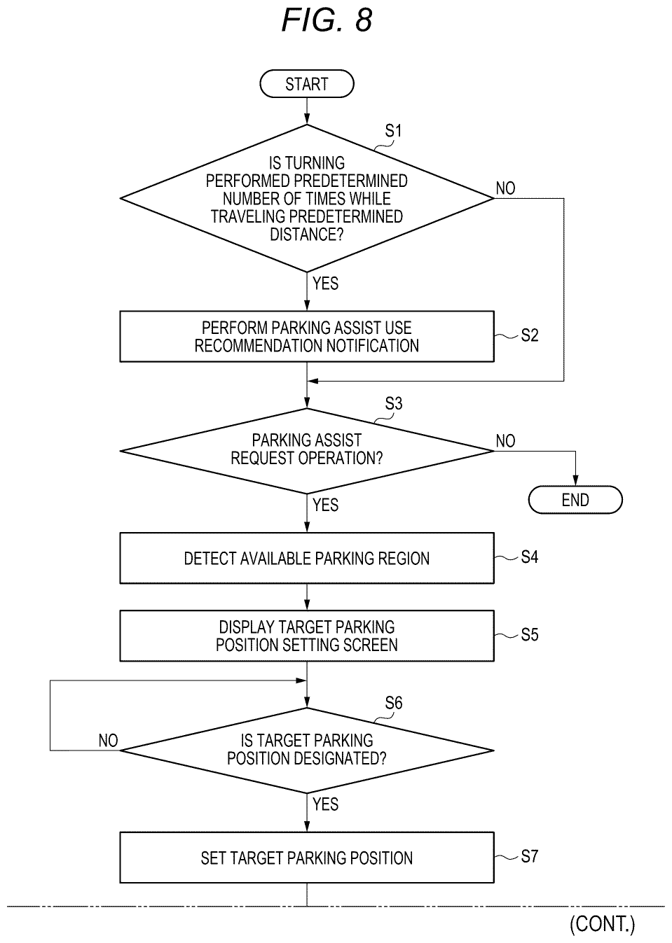

When the vehicle 1 reaches the point P1, as shown in FIG. 6, the travel control unit 34 causes the vehicle 1 to travel along the second travel route Rt2 from the point P1, which is the connection point Pc, to the available parking region PA, which is the target parking position (see an arrow β in FIG. 6). At this time, the travel control unit 34 may control the steering of the vehicle 1 via the EPS system 40 such that the vehicle 1 travels to the available parking region PA while tracing the second travel route Rt2. At this time, the travel control unit 34 may control the driving force of the vehicle 1 via the driving force control system 50, or may control the braking force of the vehicle 1 via the braking force control system 60. However, the present disclosure is not limited thereto, and the driving force or the braking force of the vehicle 1 may be adjusted by the user via the accelerator pedal 52 or the brake pedal 62, for example. In other words, the control device 30 may control only the steering of the vehicle 1.

As described above, according to the control device 30, even if the user fails to park in a desired available parking region (for example, the available parking region PA shown in FIG. 3 or the like) by manual driving, the vehicle 1 can be easily parked in the available parking region. Accordingly, convenience of the user can be improved. Further, it is possible to improve traffic safety and contribute to development of a sustainable transportation system.

Further, according to the control device 30, the travel to the connection point Pc along the first travel route Rt1 and the travel to the available parking region PA along the second travel route Rt2 can be performed continuously in response to the parking assist request operation. Accordingly, the user can park the vehicle 1 in a desired available parking region without taking time and effort as compared with a case where a predetermined start operation is required for each of travel along the first travel route Rt1 (in other words, travel for returning the vehicle 1 to a previous position) and travel along the second travel route Rt2 (in other words, travel for parking in the target parking position). Therefore, the convenience of the user can be improved.

A plurality of available parking regions may be detected by the detection unit 31. When a plurality of available parking regions are detected as described above, the derivation unit 33 may derive the second travel route Rt2 for causing the vehicle 1 to travel to one available parking region designated by the user (that is, the available parking region designated as the target parking position) among the plurality of detected available parking regions. Accordingly, even if there are a plurality of available parking regions in the periphery of the vehicle 1, the user can park the vehicle 1 in a desired available parking region, and thus the convenience of the user can be improved.

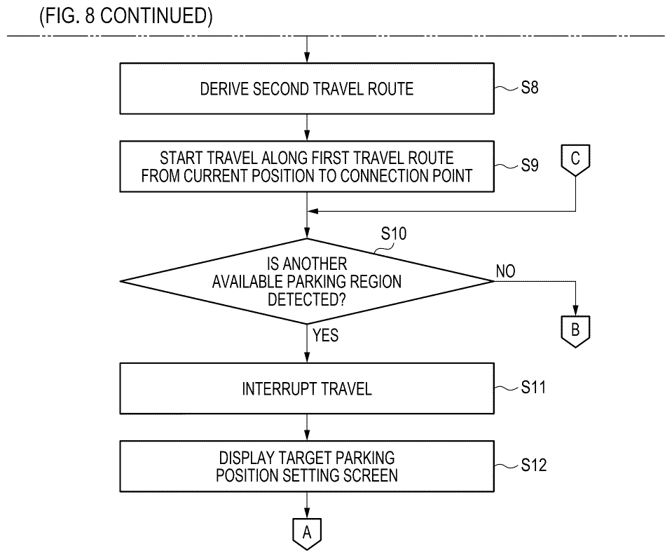

The derivation unit 33 may derive a plurality of second travel routes Rt2. For example, as shown in FIG. 7, the derivation unit 33 may derive, as the plurality of second travel routes Rt2, a second travel route Rt2a for causing the vehicle 1 to travel from a point P1a on the first travel route Rt1 to the available parking region PA (that is, the target parking position), and a second travel route Rt2b for causing the vehicle 1 to travel from a point P1b on the first travel route Rt1 to the available parking region PA.

In the example shown in FIG. 7, two second travel routes including the second travel route Rt2a and the second travel route Rt2b are derived as the plurality of second travel routes Rt2, but three or more second travel routes Rt2 may be derived. As an example, the derivation unit 33 may take candidate points on the first travel route Rt1 at predetermined intervals (for example, intervals of 0.5 [m]) from the current position of the vehicle 1 and derive the second travel route Rt2 for causing the vehicle 1 to travel from each of the candidate points to the available parking region PA. Further, in order to reduce a required time and a processing load at the time of deriving the second travel route Rt2, among the points on the first travel route Rt1, only points included in a predetermined range based on the available parking region PA (for example, a range of a radius of 30 [m] centered on the available parking region PA) may be set as the candidate points.

In this way, by deriving the plurality of second travel routes Rt2, it is possible to cause the vehicle 1 to travel in a more preferable manner based on the first travel route Rt1 and the second travel route Rt2.

As an example, it is possible to cause the vehicle 1 to travel based on one second travel route Rt2 (hereinafter, also referred to as “shortest second route Rt2X”) having a shortest travel distance to the available parking region PA among the plurality of second travel routes Rt2. In this case, the travel control unit 34 may first cause the vehicle 1 to travel along the first travel route Rt1 from the current position of the vehicle 1 to the connection point Pc between the first travel route Rt1 and the shortest second route Rt2X (in other words, a point on the first travel route Rt1 corresponding to the shortest second route Rt2X). Thereafter, the travel control unit 34 may cause the vehicle 1 to travel along the shortest second route Rt2X from the connection point Pc between the first travel route Rt1 and the shortest second route Rt2X to the available parking region PA.

More specifically, in the example shown in FIG. 7, the second travel route Rt2a is the shortest second route Rt2X. Therefore, in this case, the travel control unit 34 may first cause the vehicle 1 to travel along the first travel route Rt1 from the point P0, which is the current position of the vehicle 1, to the point P1a, which is the connection point Pc between the first travel route Rt1 and the second travel route Rt2a (that is, the shortest second route Rt2X). Thereafter, the travel control unit 34 may cause the vehicle 1 to travel along the second travel route Rt2a from the point P1a to the available parking region PA.

In this way, by causing the vehicle 1 to travel based on the shortest second route Rt2X, a travel distance to the available parking region PA can be shortened as compared with a case where the vehicle 1 travels based on another second travel route Rt2. Therefore, it is possible to reduce a time required to park the vehicle 1 in the available parking region PA and energy consumption of the vehicle 1.

Further, by deriving the plurality of second travel routes Rt2, it is also possible to cause the vehicle 1 to travel based on one second travel route Rt2 (hereinafter, also referred to as “turning-minimized second route Rt2Y”) in which the number of times of turning of the vehicle 1 when traveling to the available parking region PA is minimized. In this case, the travel control unit 34 may first cause the vehicle 1 to travel along the first travel route Rt1 from the current position of the vehicle 1 to the connection point Pc between the first travel route Rt1 and the turning-minimized second route Rt2Y (in other words, a point on the first travel route Rt1 corresponding to the turning-minimized second route Rt2Y). Thereafter, the travel control unit 34 may cause the vehicle 1 to travel along the turning-minimized second route Rt2Y from the connection point Pc between the first travel route Rt1 and the turning-minimized second route Rt2Y to the available parking region PA.

In this way, by causing the vehicle 1 to travel based on the turning-minimized second route Rt2Y, the number of times of turning required to park the vehicle 1 in the available parking region PA can be reduced as compared with a case where the vehicle 1 travels based on another second travel route Rt2. Therefore, it is possible to reduce the time required to park the vehicle 1 in the available parking region PA and wear of the tire due to the turning. Here, the wear of the tire due to the turning is, for example, wear of the tire due to so-called “stationary steering” at the time of turning.

In a case where the vehicle 1 is manually driven and the vehicle 1 is turned a predetermined number of times (for example, three times), which is two or more times, while traveling a predetermined distance (for example, 20 [m]), the user may have difficulty in parking the vehicle 1.

Therefore, the display control unit 32 of the control device 30 may perform the parking assist function use recommendation notification, which is a notification prompting to use the parking assist function, when the vehicle 1 is manually driven and the vehicle 1 is turned a predetermined number of times, which is two or more, while traveling a predetermined distance. Here, the predetermined distance and the predetermined number of times can be appropriately determined by the manufacturer or the like of the vehicle 1.

As an example, the display control unit 32 may perform the parking assist function use recommendation notification by displaying a message prompting to use the parking assist function (for example, a message such as “parking can be performed using the parking assist function”) on the touch panel 22 or the MID 91. That is, the display control unit 32 is an example of a notification control unit in the present disclosure.

Then, the travel control unit 34 may cause the vehicle 1 to travel based on the first travel route Rt1 and the second travel route Rt2 (that is, activate the parking assist function) in response to the parking assist request operation being performed by the user who receives the parking assist function use recommendation notification. In this way, the parking assist function use recommendation notification can be performed at a timing at which the user desires the parking assist function, the use of the parking assist function can be promoted while preventing excessive notifications, and the convenience of the user can be improved.

Instead of or in addition to the above, the control device 30 may perform the parking assist function use recommendation notification by outputting a voice or a sound effect for prompting to use the parking assist function from the speaker 23 or the buzzer 92.

Further, when the vehicle 1 is traveling based on the first travel route Rt1 or the second travel route Rt2, another vehicle that is parked may move or the like, and another available parking region different from the available parking region set as the target parking position may get to a state where the vehicle 1 can be parked. In such a case, the user may want to change the target parking position to another available parking region.

Therefore, when the vehicle 1 travels based on the first travel route Rt1 or the second travel route Rt2, the travel control unit 34 may interrupt the travel of the vehicle 1 when another available parking region different from the available parking region set as the target parking position is detected. At this time, the display control unit 32 may display the target parking position setting screen on the touch panel 22.

Then, when there is no operation of changing a parking position of the vehicle 1 (hereinafter, also referred to as “parking position changing operation”, for example, an operation of tapping the parking frame image corresponding to another available parking region in the target parking position setting screen), the travel control unit 34 may restart the interrupted travel of the vehicle 1. On the other hand, when there is a parking position changing operation, the travel control unit 34 may cause the vehicle 1 to travel from the position where the travel of the vehicle 1 is interrupted to another available parking region (in other words, a new target parking position). In this way, even when the vehicle 1 is traveling based on the first travel route Rt1 or the second travel route Rt2, the position where the vehicle 1 is to be parked can be changed as another available parking region is detected, and thus the convenience of the user is improved.

### 2-3. Processing Performed by Control Device

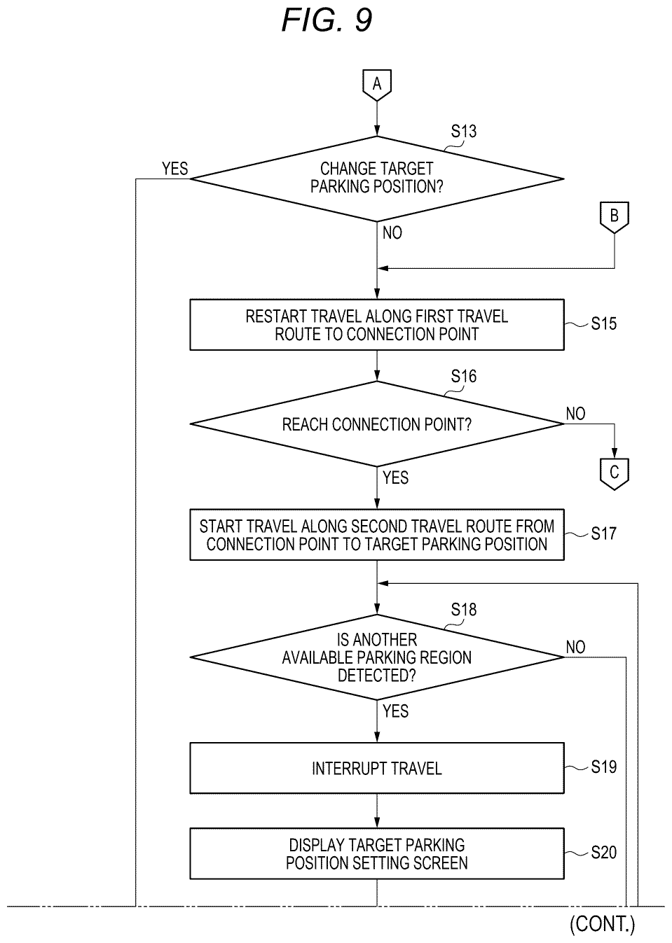

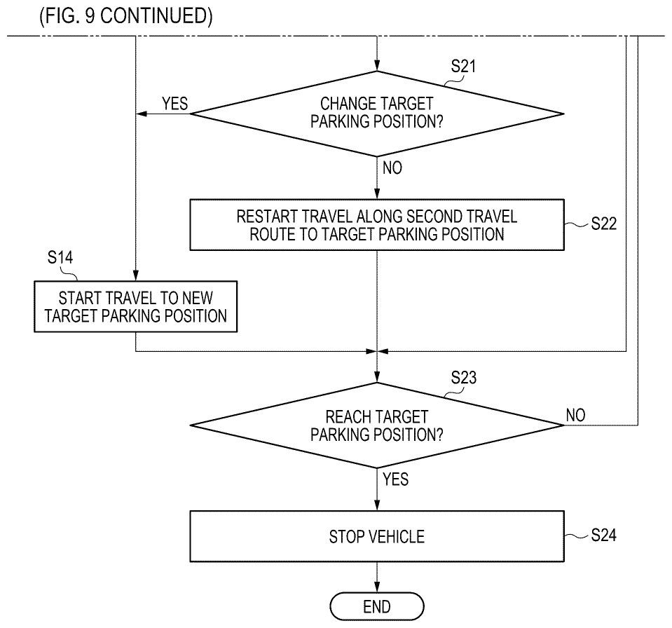

Next, an example of processing performed by the control device 30 will be described with reference to FIGS. 8 and 9.

As shown in FIG. 8, first, the control device 30 determines whether turning is performed a predetermined number of times, which is two or more times, while the vehicle 1 travels a predetermined distance (step S1). When it is determined that the turning is not performed the predetermined number of times (step S1: NO), the control device 30 directly proceeds to processing in step S3. When it is determined that the turning is performed the predetermined number of times (step S1: YES), the control device 30 proceeds to processing in step S2.

As an example, in the processing in step S1, the control device 30 refers to the travel history information 200 stored in the storage unit 35, and determines whether shift switching from “R” to “D” or from “D” to “R” (that is, shift switching for reversing a travel direction of the vehicle 1) is performed a predetermined number of times, which is two or more times, while the vehicle 1 travels a predetermined distance. When it is determined that the shift switching is not performed the predetermined number of times, the control device 30 determines that the turning is not performed the predetermined number of times, and proceeds to the processing in step S3. On the other hand, when it is determined that the shift switching is performed the predetermined number of times, the control device 30 determines that the turning is performed the predetermined number of times, and proceeds to the processing in step S2.

Next, the control device 30 performs the parking assist function use recommendation notification (step S2). As an example, in the processing in step S2, the control device 30 may perform the parking assist function use recommendation notification by displaying a message prompting to use the parking assist function on the touch panel 22 or the MID 91. As another example, the control device 30 may perform the parking assist function use recommendation notification by outputting, from the speaker 23 or the buzzer 92, a voice or a sound effect prompting to use the parking assist function.

Next, the control device 30 determines whether there is a parking assist request operation (step S3). When it is determined that there is no parking assist request operation (step S3: NO), the control device 30 ends the series of processing. When it is determined that there is a parking assist request operation (step S3: YES), the control device 30 detects an available parking region (for example, the available parking region PA shown in FIG. 3 or the like) based on the external environment information acquired via the external environment sensor 11 (step S4).

Next, the control device 30 displays, on the touch panel 22, the target parking position setting screen for allowing the user to designate which available parking region among the detected available parking regions is to be set as the target parking position (step S5).

Next, the control device 30 determines whether the target parking position is designated by the user (step S6). When it is determined that the target parking position is not designated (step S6: NO), the control device 30 repeats the processing in step S6 until the target parking position is designated. When it is determined that the target parking position is designated (step S6: YES), the control device 30 proceeds to processing in step S7.

As an example, when any one of the parking frame images in the target parking position setting screen displayed by the processing in step S5 is tapped by the user in the processing in step S6, the control device 30 determines that an available parking region corresponding to the parking frame image is designated as the target parking position by the user, and proceeds to the processing in step S7. When none of the parking frame images in the target parking position setting screen is tapped, the control device 30 determines that the target parking position is not designated, and repeats the processing in step S6.

Next, the control device 30 sets the available parking region designated by the user as the target parking position (step S7). Then, the control device 30 derives the second travel route Rt2 based on the available parking region set as the target parking position and the first travel route Rt1 indicated by the travel history information 200 (step S8). In the processing in step S8, the control device 30 may derive a plurality of second travel routes Rt2. In this way, the vehicle 1 can travel based on the shortest second route Rt2X or the turning-minimized second route Rt2Y.

Next, the control device 30 starts the travel of the vehicle 1 along the first travel route Rt1 from the current position of the vehicle 1 to the connection point Pc (step S9). Here, the connection point Pc is a point on the first travel route Rt1 and is a start point of the second travel route Rt2 derived by the processing in step S8.

Next, the control device 30 determines whether another available parking region different from the available parking region set as the target parking position is detected based on the external environment information acquired via the external environment sensor 11 (step S10). When it is determined that no other available parking region is detected (step S10: NO), the control device 30 proceeds to processing in step S15 to be described later.

When it is determined that another available parking region is detected (step S10: YES), the control device 30 interrupts the travel of the vehicle 1 (step S11), and displays the target parking position setting screen on the touch panel 22 (step S12). Accordingly, the other available parking region that is detected can be guided to the user, and the parking position changing operation for changing the target parking position to the other available parking region can be received.

Then, as shown in FIG. 9, the control device 30 determines whether to change the target parking position (step S13). As an example, in the processing in step S13, the control device 30 determines to change the target parking position when the parking position changing operation is received via the target parking position setting screen displayed by the processing in step S12.

When it is determined to change the target parking position (step S13: YES), the control device 30 sets another available parking region designated by the user as a new target parking position, starts traveling to the new target parking position (step S14), and proceeds to processing in step S23 to be described later.

When it is determined not to change the target parking position (step S13: NO), the control device 30 restarts the travel of the vehicle 1 along the first travel route Rt1 to the connection point Pc, which is started by the processing in step S9 (step S15).

Then, the control device 30 determines whether the vehicle 1 reaches the connection point Pc (step S16). When it is determined that the connection point Pc does not reach (step S16: NO), the control device 30 returns to the processing in step S10.

When it is determined that the vehicle 1 reaches the connection point Pc (step S16: YES), the control device 30 starts the travel of the vehicle 1 along the second travel route Rt2 from the connection point Pc to the available parking region that is the target parking position (step S17).

Next, the control device 30 determines whether another available parking region different from the available parking region set as the target parking position is detected based on the external environment information acquired via the external environment sensor 11 (step S18). When it is determined that no other available parking region is detected (step S18: NO), the control device 30 proceeds to processing in step S23 to be described later.

When it is determined that another available parking region is detected (step S18: YES), the control device 30 interrupts the travel of the vehicle 1 (step S19), and displays the target parking position setting screen on the touch panel 22 (step S20). Accordingly, the other available parking region that is detected can be guided to the user, and the parking position changing operation for changing the target parking position to the other available parking region can be received.

Then, the control device 30 determines whether to change the target parking position (step S21). As an example, in the processing in step S21, the control device 30 determines to change the target parking position when the parking position changing operation is received via the target parking position setting screen displayed by the processing in step S20.

When it is determined to change the target parking position (step S21: YES), the control device 30 proceeds to the processing in step S14. When it is determined not to change the target parking position (step S21: NO), the control device 30 restarts the travel of the vehicle 1 along the second travel route Rt2 to the target parking position, which is started by the processing in step S17 (step S22).

Then, the control device 30 determines whether the vehicle 1 reaches the available parking region set as the target parking position (step S23). When it is determined that the vehicle 1 does not reach the available parking region set as the target parking position (step S23: NO), the control device 30 returns to the processing in step S18. When it is determined that the vehicle 1 reaches the available parking region set as the target parking position (step S23: YES), the control device 30 stops the vehicle 1 (step S24), and ends the series of processing.

As described above, according to the control device 30, even if the user fails to park in a desired available parking region by manual driving, the vehicle 1 can be easily parked in the available parking region by using the parking assist function of the control device 30. Accordingly, the convenience of the user can be improved. Further, it is possible to improve the traffic safety and contribute to the development of a sustainable transportation system.

### 3. Modification

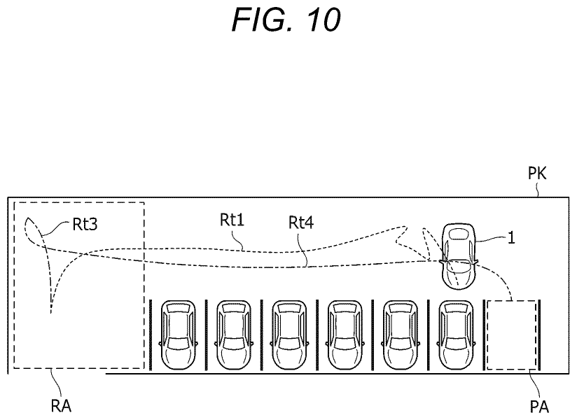

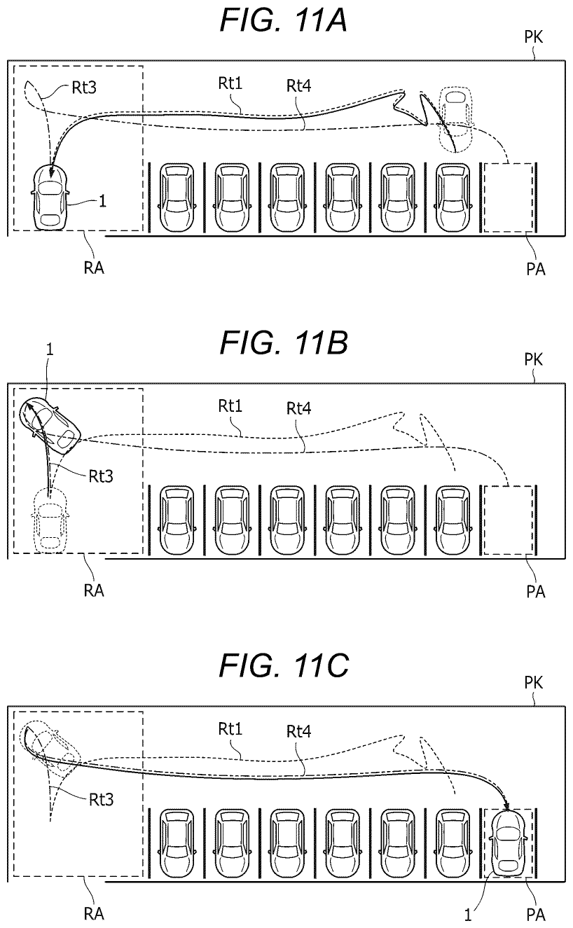

Next, a modification of the above-described embodiment will be described with reference to FIGS. 10, 11A, 11B and 11C. In the following, portions different from those of the above-described embodiment will be mainly described, and portions common to those of the above-described embodiment will be denoted by the same reference numerals, and description thereof will be omitted or simplified.

For example, depending on a positional relationship between the vehicle 1 and the available parking region, the environment in the periphery of the vehicle 1 and the available parking region, or the like, the derivation unit 33 may not be able to derive an appropriate second travel route Rt2. More specifically, a case where the second travel route Rt2 cannot be derived in the first place, a case where the travel distance becomes too long when the vehicle 1 travels based on the derived second travel route Rt2, or a case where many number of times of turning occur when the vehicle 1 travels based on the derived second travel route Rt2 may also occur. In such cases, it may be impossible or undesirable to cause the vehicle 1 to travel based on the second travel route Rt2.

Therefore, as shown in FIG. 10, for example, when the appropriate second travel route Rt2 cannot be derived and the reversible region RA in which the direction of the vehicle 1 can be reversed is present adjacent to the first travel route Rt1, the derivation unit 33 may derive a third travel route Rt3 for reversing the direction of the vehicle 1 in the reversible region RA and a fourth travel route Rt4 for causing the vehicle 1 whose direction is reversed in the reversible region RA to travel from the reversible region RA to the available parking region PA. Here, the reversible region RA can be, for example, a region in which the direction of the vehicle 1 can be reversed by turning once. That is, the reversible region RA can be, for example, a region having a size sufficient to perform turning to reverse the direction of the vehicle 1.

In this case, as shown in FIGS. 11A, 11B, and 11C, for example, the travel control unit 34 may cause the vehicle 1 to travel to the reversible region RA along the first travel route Rt1 (see FIG. 11A), then reverse the direction of the vehicle 1 in the reversible region RA along the third travel route Rt3 (see FIG. 11B), and cause the vehicle 1 to travel from the reversible region RA to the available parking region PA along the fourth travel route Rt4 (see FIG. 11C).

In this way, even in a case where the vehicle 1 cannot be appropriately parked in the available parking region PA unless the direction of the vehicle 1 is reversed, the user can park the vehicle 1 in the available parking region PA without taking time and effort as long as the reversible region RA is present adjacent to the first travel route Rt1. Therefore, the convenience of the user can be improved.

Further, similarly to the above-described embodiment, in a case where the vehicle 1 travels based on the first travel route Rt1, the third travel route Rt3, or the fourth travel route Rt4, when another available parking region different from the available parking region set as the target parking position is detected, the travel control unit 34 may interrupt the travel of the vehicle 1.

Then, when there is no parking position changing operation, the travel control unit 34 may restart the interrupted travel of the vehicle 1. On the other hand, when there is a parking position changing operation, the travel control unit 34 may cause the vehicle 1 to travel from the position where the travel of the vehicle 1 is interrupted to another available parking region (in other words, a new target parking position). In this way, even if the vehicle 1 travels based on the first travel route Rt1, the third travel route Rt3 or the fourth travel route Rt4, the position where the vehicle 1 is to be parked can be changed as another available parking region is detected, and thus the convenience of the user is improved.

As described above, according to the present embodiment and the modification thereof, the convenience of the user can be improved. Further, it is possible to improve the traffic safety and contribute to the development of a sustainable transportation system.

Although various embodiments have been described above with reference to the drawings, it is needless to say that the present disclosure is not limited to these examples. It is apparent to those skilled in the art that various changes or modifications can be conceived within the scope described in the claims, and it is understood that the changes or modifications naturally fall within the technical scope of the present disclosure. In addition, the constituent elements in the above embodiment may be freely combined without departing from the gist of the disclosure.

The control method described in the above embodiment may be implemented by executing a program (control program) prepared in advance on a computer. For example, the present program is stored in a computer-readable storage medium and executed by being read from the storage medium. In addition, the present program may be provided in a form of being stored in a nonvolatile (non-transitory) storage medium such as a flash memory, or may be provided via a network such as the Internet.

In the embodiment described above, the computer that executes the program is the control device 30 provided in the vehicle 1, but the present disclosure is not limited thereto. For example, the computer that executes the present program may be provided in another device (for example, the external device 2) capable of communicating with the control device 30.

In the present description, at least the following matters are described. In the parentheses, the corresponding constituent elements and the like in the above embodiment are shown as examples, but the present disclosure is not limited thereto.

(1) A control device (control device 30) for controlling a vehicle (vehicle 1), including:
a detection unit (detection unit 31) configured to detect at least one available parking region (available parking region PA) in which the vehicle is able to be parked based on external environment information on a periphery of the vehicle;
a derivation unit configured to refer to a storage unit (storage unit 35) that stores travel route information indicating a first travel route (first travel route Rt1) along which the vehicle travels to a current position (point P0), to derive a second travel route (second travel route Rt2) for causing the vehicle to travel from a predetermined point (point P1, connection point Pc) on the first travel route to the at least one available parking region; and
a travel control unit (travel control unit 34) configured to cause the vehicle to travel based on the first travel route and the second travel route, in which
the travel control unit causes the vehicle to travel from the current position to the predetermined point along the first travel route and then causes the vehicle to travel from the predetermined point to the at least one available parking region along the second travel route.

According to (1), even if a user fails to park in a desired available parking region by manual driving, the vehicle can be easily parked in the available parking region. Accordingly, convenience of the user can be improved. Further, it is possible to improve traffic safety and contribute to development of a sustainable transportation system.

(2) The control device according to (1), in which
the travel control unit causes the vehicle to travel to the predetermined point along the first travel route and causes the vehicle to travel to the at least one available parking region along the second travel route sequentially, in response to a predetermined operation performed by a user of the vehicle.

According to (2), as compared with a case where a predetermined start operation is required for each of the travel along the first travel route and the travel along the second travel route, the user can park the vehicle in a desired available parking region without taking time and effort. Therefore, the convenience of the user can be improved.

(3) The control device according to (1) or (2), in which the at least one available parking region includes a plurality of available parking regions,
in response to the plurality of available parking regions being detected, the derivation unit derives the second travel route for causing the vehicle to travel to one available parking region designated by a user of the vehicle among the plurality of available parking regions.

According to (3), even if there are a plurality of available parking regions in the periphery of the vehicle, the user can park the vehicle in a desired available parking region, and thus the convenience of the user can be improved.

(4) The control device according to (1) or (2), in which
the derivation unit derives the second travel route (second travel route Rt2a, second travel route Rt2b) for causing the vehicle to travel from each of a plurality of points (point P1a, point P1b) on the first travel route to the at least one available parking region, and
the travel control unit causes the vehicle to travel along the first travel route to one of the points (point P1a) on the first travel route corresponding to one second travel route (second travel route Rt2a, shortest second route Rt2X) having a shortest travel distance to the available parking region among the plurality of second travel routes, and then causes the vehicle to travel along the one second travel route from the one point to the available parking region.

According to (4)(, the travel distance to the available parking region can be shortened as compared with a case where the vehicle travels based on another second travel route other than the one second travel route. Therefore, it is possible to reduce a time required to park the vehicle in the available parking region and energy consumption of the vehicle.

(5) The control device according to (1) or (2), in which
the derivation unit derives the second travel route for causing the vehicle to travel from each of a plurality of points on the first travel route to the available parking region, and
the travel control unit causes the vehicle to travel along the first travel route to one of the points corresponding to one second travel route (turning-minimized second route Rt2Y), in which the number of times of turning the vehicle when traveling to the available parking region is minimized, among the plurality of second travel routes, and then causes the vehicle to travel along the one second travel route from the one point to the available parking region.

According to (5), as compared with a case where the vehicle travels based on another second travel route other than the one second travel route, the number of times of turning required to park the vehicle in the available parking region can be reduced. Therefore, it is possible to reduce the time required to park the vehicle in the available parking region and wear of tires due to the turning.

According to (6), a notification promoting to use the parking assist function can be performed at a timing at which the user desires the parking assist function, the use of the parking assist function can be promoted while preventing excessive notifications, and the convenience of the user can be improved.

(7) The control device according to (1) or (2), in which
in a case where the second travel route is not able to be derived and a reversible region (reversible region RA) in which a direction of the vehicle is reversible is present adjacent to the first travel route, the derivation unit derives a third travel route (third travel routeRt3) for reversing the direction of the vehicle in the reversible region and a fourth travel route (fourth travel route Rt4) for causing the vehicle whose direction is reversed in the reversible region to travel from the reversible region to the available parking region, and
the travel control unit causes the vehicle to travel to the reversible region along the first travel route, then reverses the direction of the vehicle in the reversible region along the third travel route, and causes the vehicle to travel from the reversible region to the available parking region along the fourth travel route.

According to (7), even in a case where the vehicle cannot be appropriately parked in the available parking region unless the direction of the vehicle is reversed, as long as the reversible region is present adjacent to the first travel route, the user can park the vehicle in the available parking region without taking time and effort. Therefore, the convenience of the user can be improved.

(8) The control device according to (1) or (2), in which
the travel control unit is further configured to,
   in response to another available parking region different from the at least one available parking region being detected while the vehicle is traveling based on the first travel route or the second travel route, interrupt the travel,
   in response to operation of changing a parking position of the vehicle not being performed, restart the interrupted travel, and,
   in response to the operation, cause the vehicle to travel from a position where the travel is interrupted to the other available parking region.

According to (8), even when the vehicle is traveling based on the first travel route or the second travel route, the position where the vehicle is to be parked can be changed as another available parking region is detected, and thus the convenience of the user is improved.

(9) A control method including:
detecting, by a computer (control device 30) that controls a vehicle, an available parking region (available parking region PA) in which the vehicle is able to be parked based on external environment information in a periphery of the vehicle;
referring, by the computer, to a storage unit (storage unit 35) configured to store travel route information indicating a first travel route (first travel route Rt1) along which the vehicle travels to a current position (point P0), to derive (step S8) a second travel route (second travel route Rt2) for causing the vehicle to travel from a predetermined point (point P1, connection point Pc) on the first travel route to the available parking region; and
causing (step S9, step S17), by the computer, the vehicle to travel based on the first travel route and the second travel route, in which
the causing of the vehicle to travel includes causing (step S9) the vehicle to travel to the predetermined point along the first travel route and then causing (step S17) the vehicle to travel from the predetermined point to the available parking region along the second travel route.

According to (9), even if the user fails to park in a desired available parking region by manual driving, the vehicle can be easily parked in the available parking region. Accordingly, the convenience of the user can be improved. Further, it is possible to improve the traffic safety and contribute to the development of the sustainable transportation system.

(10) A non-transitory computer-readable storage medium storing a control program causing a computer (control device 30) that controls a vehicle (vehicle 1), to execute a process including:
detecting an available parking region (available parking region PA) in which the vehicle is able to be parked based on external environment information in a periphery of the vehicle;
referring to a storage unit (storage unit 35) configured to store travel route information indicating a first travel route (first travel route Rt1) along which the vehicle travels to a current position (point P0), to derive (step S8) a second travel route (second travel route Rt2) for causing the vehicle to travel from a predetermined point (point P1, connection point Pc) on the first travel route to the available parking region; and
causing (step S9, step S17) the vehicle to travel based on the first travel route and the second travel route, in which
the causing of the vehicle to travel includes causing (step S9) the vehicle to travel to the predetermined point along the first travel route and then causing (step S17) the vehicle to travel from the predetermined point to the available parking region along the second travel route.

According to (10), even if the user fails to park in a desired available parking region by manual driving, the vehicle can be easily parked in the available parking region. Accordingly, the convenience of the user can be improved. Further, it is possible to improve the traffic safety and contribute to the development of the sustainable transportation system.

What is claimed is:

1. A control device for controlling a vehicle, comprising:
a detection unit configured to detect at least one available parking region in which the vehicle is able to be parked based on external environment information on a periphery of the vehicle;
a derivation unit configured to refer to a storage unit that stores travel route information indicating a first travel route along which the vehicle travels to a current position, to derive a second travel route for causing the vehicle to travel from a predetermined point on the first travel route to the at least one available parking region; and
a travel control unit configured to cause the vehicle to travel based on the first travel route and the second travel route, wherein the travel control unit causes the vehicle to travel from the current position to the predetermined point along the first travel route and then causes the vehicle to travel from the predetermined point to the at least one available parking region along the second travel route.

2. The control device according to claim 1, wherein
the travel control unit causes the vehicle to travel to the predetermined point along the first travel route and causes the vehicle to travel to the at least one available parking region along the second travel route sequentially, in response to a predetermined operation performed by a user of the vehicle.

3. The control device according to claim 1, wherein
the at least one available parking region includes a plurality of available parking regions,
in response to the plurality of available parking regions being detected, the derivation unit derives the second travel route for causing the vehicle to travel to one available parking region designated by a user of the vehicle among the plurality of available parking regions.

4. The control device according to claim 1, wherein
the derivation unit derives the second travel route for causing the vehicle to travel from each of a plurality of points on the first travel route to the at least one available parking region, and
the travel control unit causes the vehicle to travel along the first travel route to one of the points on the first travel route corresponding to one second travel route having a shortest travel distance to the available parking region among the plurality of second travel routes, and then causes the vehicle to travel along the one second travel route from the one point to the available parking region.

5. The control device according to claim 1, wherein
the derivation unit derives the second travel route for causing the vehicle to travel from each of a plurality of points on the first travel route to the available parking region, and
the travel control unit causes the vehicle to travel along the first travel route to one of the points corresponding to one second travel route, in which the number of times of turning the vehicle when traveling to the available parking region is minimized, among the plurality of second travel routes, and then causes the vehicle to travel along the one second travel route from the one point to the available parking region.

6. The control device according to claim 1, further comprising:
a notification control unit configured to control a notification unit that performs a notification to a user of the vehicle, wherein
in response to turning being performed a predetermined number of times more than two when the vehicle is being manually driven, while the vehicle travels a predetermined distance, the notification control unit performs, via the notification unit, a notification prompting to use a parking assist function to the user of the vehicle, and
the travel control unit causes the vehicle to travel along the first travel route to the predetermined point in response to an operation requesting to use the parking assist function, and then causes the vehicle to travel from the predetermined point to the available parking region along the second travel route.

7. The control device according to claim 1, wherein
in a case where the second travel route is not able to be derived and a reversible region in which a direction of the vehicle is reversible is present adjacent to the first travel route, the derivation unit derives a third travel route for reversing the direction of the vehicle in the reversible region and a fourth travel route for causing the vehicle whose direction is reversed in the reversible region to travel from the reversible region to the available parking region, and the travel control unit causes the vehicle to travel to the reversible region along the first travel route, then reverses the direction of the vehicle in the reversible region along the third travel route, and causes the vehicle to travel from the reversible region to the available parking region along the fourth travel route.

8. The control device according to claim 1, wherein
the travel control unit is further configured to,
in response to another available parking region different from the at least one available parking region being detected while the vehicle is traveling based on the first travel route or the second travel route, interrupt the travel,
in response to operation of changing a parking position of the vehicle not being performed, restart the interrupted travel, and,
in response to the operation, cause the vehicle to travel from a position where the travel is interrupted to the other available parking region.

9. A control method comprising:
detecting, by a computer that controls a vehicle, an available parking region in which the vehicle is able to be parked based on external environment information in a periphery of the vehicle;
referring, by the computer, to a storage unit configured to store travel route information indicating a first travel route along which the vehicle travels to a current position, to derive a second travel route for causing the vehicle to travel from a predetermined point on the first travel route to the available parking region; and
causing, by the computer, the vehicle to travel based on the first travel route and the second travel route, wherein
in the causing of the vehicle to travel, the vehicle travels to the predetermined point along the first travel route and then the vehicle travels from the predetermined point to the available parking region along the second travel route.

10. A non-transitory computer-readable storage medium storing a control program causing a computer, that controls a vehicle, to execute a process comprising:
detecting an available parking region in which the vehicle is able to be parked based on external environment information in a periphery of the vehicle;
referring to a storage unit configured to store travel route information indicating a first travel route along which the vehicle travels to a current position, to derive a second travel route for causing the vehicle to travel from a predetermined point on the first travel route to the available parking region; and
causing the vehicle to travel based on the first travel route and the second travel route, wherein
in the causing of the vehicle to travel, the vehicle travels to the predetermined point along the first travel route and then the vehicle travels from the predetermined point to the available parking region along the second travel route.
